(19) United States
(12) Patent Application Publication
(10) Pub. No.: US 2026/0075346 A1
(43) Pub. Date: Mar. 12, 2026

(54) EAR DEVICE, EAR-MOUNTED UNIT, AND METHOD FOR SWITCHING MOUNTING STATE OF EAR DEVICE

(71) Applicant: CASIO COMPUTER CO., LTD., Tokyo (JP)

(72) Inventor: Reigo RYU, Tokyo (JP)

(73) Assignee: CASIO COMPUTER CO., LTD., Tokyo (JP)

(21) Appl. No.: 19/325,232

(22) Filed: Sep. 10, 2025

(30) Foreign Application Priority Data
Sep. 11, 2024 (JP) 2024-157171

(51) Int. Cl. H04R 1/10

(52) U.S. Cl. CPC H04R 1/1041; H04R 1/1008; H04R 1/105

(57) ABSTRACT

Disclosed is an ear device including: a housing; a sound emission rod that is connected to the housing and has a sound hole; and a movement adjuster that moves the sound emission rod in an axial direction of the sound emission rod relative to the housing according to a user operation on the movement adjuster. According to the user operation, a state of the sound emission rod is switchable between: a closed state in which the sound hole of the sound emission rod is to be placed inside an external auditory meatus of an ear of a user; and an open state in which the sound hole of the sound emission rod is to be placed outside the external auditory meatus.

### REFERENCE TO RELATED APPLICATIONS

This application is based upon and claims the benefit of priority from the prior Japanese Patent Application No. 2024-157171 filed on Sep. 11, 2024, the entire contents of which are incorporated herein by reference.

### TECHNICAL FIELD

This invention relates to an ear device, an ear-mounted unit, and a method for switching a mounting state of an ear device.

### DESCRIPTION OF RELATED ART

Ear devices such as earphones have been classified into open-type and closed-type. Each type has its own advantages and disadvantages, and there is a demand for switching between them depending on the situation.

### SUMMARY OF THE INVENTION

An ear device according to the present disclosure comprises: a housing; a sound emission rod that is connected to the housing and has a sound hole; and a movement adjuster that moves the sound emission rod in an axial direction of the sound emission rod relative to the housing according to a user operation on the movement adjuster, wherein according to the user operation, a state of the sound emission rod is switchable between: a closed state in which the sound hole of the sound emission rod is to be placed inside an external auditory meatus of an ear of a user; and an open state in which the sound hole of the sound emission rod is to be placed outside the external auditory meatus.

### BRIEF DESCRIPTION OF DRAWINGS

In the drawings:

FIG. 1 is a perspective view of a main portion of an ear-mounted unit according to an embodiment mounted on the ear as a closed-type;

FIG. 2 is a perspective view of a main portion of the ear-mounted unit according to the embodiment mounted on the ear as an open-type;

FIG. 3 is a perspective view of a main portion of the ear device;

FIG. 4 is a cross-sectional view of a main portion of the ear device illustrated in FIG. 3;

FIG. 5 is a exploded view of a main portion of the ear device illustrated in FIG. 3;

FIG. 6 is a cross-sectional view of a main portion of the ear device illustrating how an elastic member is attached to the ear device;

FIG. 7 is a cross-sectional view of a main portion of the ear device illustrated in FIG. 4 and the like illustrating how the mounting state of the ear device is switched from an open state, in which an ear pad is placed outside the external auditory meatus, to a closed state, in which the ear pad is inserted into the external auditory meatus;

FIG. 8 is an explanatory diagram for explaining an operation of switching the mounting state of the ear device from the open state to the closed state;

FIG. 9 is a cross-sectional view of a main portion of the ear device illustrated in FIG. 4 and the like illustrating how the mounting state of the ear device is switched from the closed state, in which the ear pad is inserted into the external auditory meatus, to the open state, in which the ear pad is placed outside the external auditory meatus;

FIG. 10 is an explanatory diagram for explaining an operation of switching the mounting state of the ear device from the closed state to the open state;

FIG. 11 is a perspective view of a main portion of an ear-mounted unit according to a variation mounted on the ear;

FIG. 12 is a perspective view of a main portion of an ear-mounted unit according to a variation mounted on the ear;

FIG. 13 is a cross-sectional view of a main portion of an ear pad according to a variation; and

FIG. 14 is a cross-sectional view of a main portion of an ear pad according to a variation.

### DETAILED DESCRIPTION

JP 2016-51915A describes earphones in which right and left ear pads can be switched between open-type and closed-type as appropriate. According to this configuration, when the ear pads become open-type, it is possible to hear surrounding external sounds and the like while the earphones are mounted.

However, regardless of whether the ear device is used as a closed type or an open type, the ear pads remain inserted into the external auditory canal. Therefore, even when the ear device becomes open-type, it is not possible to eliminate discomfort caused by the presence of an insert in the external auditory meatus.

The present disclosure relates to an ear device and an ear-mounted unit that are capable of opening or closing the external auditory meatus, depending on a usage situation, and a method for switching a mounting state of an ear device.

According to the present disclosure, it is possible to obtain an effect that the external auditory meatus can be opened or closed, depending on the usage situation.

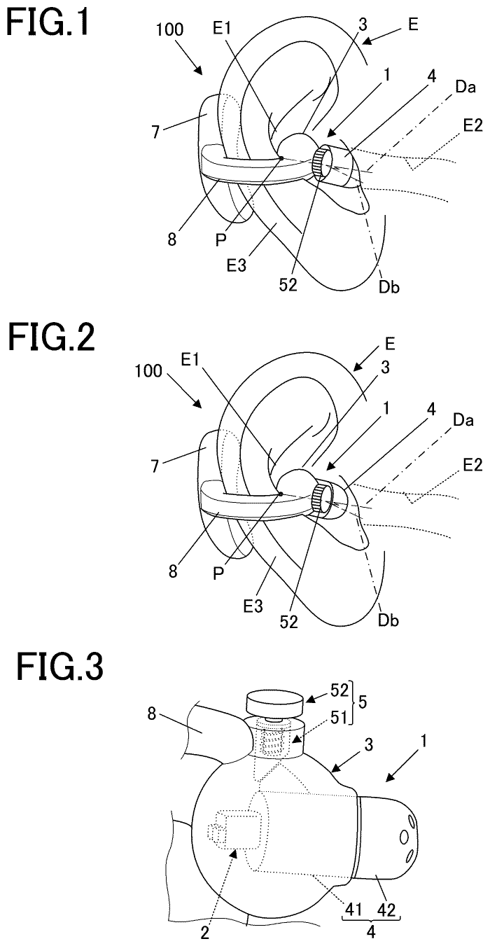

With reference to FIGS. 1 to 10, one embodiment of an ear device 1, an ear-mounted unit 100, and a method for switching the mounting state of the ear device 1 according to the present invention will be described. The embodiment described below is provided with various limitations technically preferable for carrying out the present invention. However, the scope of the present invention is not limited to the embodiment below or illustrated examples.

As illustrated in FIGS. 1 and 2, the ear-mounted unit 100 according to the embodiment includes the ear device 1, a main body 7, and an arm 8. The main body 7 includes in a housing made of resin or the like, for example, a power supplier such as a battery, a communication module for wireless communication by Bluetooth (registered trademark) or the like, and various circuit boards (all not shown). The arm 8 connects the main body 7 to the ear device 1. The ear device 1 and the ear-mounted unit 100 including the ear device 1 are mounted on the ear E of a user to be used. In the illustrated examples, the arm 8 connects the ear device 1 to the main body 7, resembling an ear cuff. The ear device 1 is placed on the front side of the ear E (the opening side of the external auditory meatus E2), and the main body 7 is placed on the back side of the earlobe E3.

As illustrated in FIGS. 3 to 5, in the embodiment, the ear device 1 includes a driver unit 2, a housing 3, a sound emission rod 4, and a movement adjuster 5. As described below, the mounting state of the ear device 1 according to the embodiment is switchable between a closed state and a open state by the movement adjuster 5 moving the sound emission rod 4 in an axial direction Da (see FIG. 1, FIG. 2, and the like). In the closed state, at least a free end portion of the sound emission rod 4 (an ear pad 42 of the sound emission rod 4) is to be inserted into the external auditory meatus E2. In the open state, the sound emission rod 4 (the ear pad 42 of the sound emission rod 4) is to be placed outside the external auditory meatus E2. When the sound emission rod 4 is in the closed state, the ear device 1 (the ear-mounted unit 100 including the ear device 1) can be used as a so-called closed-type. When the sound emission rod 4 is in the open state, the ear device 1 (the ear-mounted unit 100 including the ear device 1) can be used as a so-called open-type in which the earhole is open. The configuration of each component is described in detail below.

The driver unit 2 converts an electrical signal into a sound. Specifically, the driver unit 2 includes, for example, a diaphragm, coil, magnet, and the like (all not shown). When the ear-mounted unit 100 is an earphone, the driver unit converts an electrical signal (audio signal) supplied from an external device into a vibration. When the ear-mounted unit 100 is a hearing aid (sound collector), the ear device 1 further includes a microphone, amplifier, and the like (all not shown). The microphone is a sound wave input section (sound collecting section) that collects a sound wave (sound data) from the outside. The sound wave (sound data) collected by the microphone is input to the amplifier to be converted into an electrical signal and amplified as appropriate. Furthermore, this electrical signal is supplied to the driver unit 2 to be converted into a sound. The driver unit 2 may be built in the main body 7, and the generated sound may be guided to a sound hole 421 through a sound path (not shown) formed inside the arm 8.

The housing 3 is made of various types of resin, for example, and the outer shape is formed to be substantially spherical in examples illustrated in FIG. 3 and the like. The shape of the housing 3 is not limited to the examples illustrated in the drawings. As illustrated in FIGS. 1 and 2, the housing 3 is fit in the cavum conchae E1 when mounted, with a portion of the spherical housing 3 contacting the front of the ear E. In the embodiment, the housing 3 has an accommodation space 311 for accommodating the driver unit 2 inside. The housing 3 also supports one end portion of the sound emission rod 4 described below. In the other end (free end) portion of the sound emission rod 4, sound holes 421 are formed to emit the sound converted by the driver unit 2, and a sound path is secured from the driver unit 2 to each of the sound holes 421. That is, the housing 3 has an opening 3a on the side supporting the sound emission rod 4, and a hollow support tube 312 is formed inside the housing 3. The support tube 312 communicates with the accommodation space 311, enabling communication from the accommodation space 311 toward the opening 3a. The sound emission rod 4 is connected to the housing 3. One end portion of the sound emission rod 4 is disposed inside the housing 3, and the other end portion of the sound emission rod 4 has sound holes.

The support tube 312 is a cylindrical member coaxial with a tubular part 41 of the sound emission rod 4 described below. The support tube 312 is inserted inside the tubular part 41 when the ear device 1 is assembled. There is a gap between the outer periphery of the support tube 312 and the inner periphery of the tubular part 41, and an elastic member 6 is disposed in this gap. In the embodiment, the elastic member 6 is a coil spring and is a return spring that is contracted in its normal state. A hooking part 61 such as a hook is provided on each of one end and the other end of the elastic member 6. The hooking part 61 on one end is engaged with a first engaging portion 313 formed in the support tube 312 of the housing 3. The hooking part 61 on the other end is engaged with a second engaging portion 413 formed in the tubular part 41. The first engaging portion 313 and the second engaging portion 413 are, for example, grooves or notches. The shapes and the like of the first engaging portion 313 and the second engaging portion 413 are not particularly limited as long as the hooking parts 61 can be engaged with the engaging portions.

The housing 3 also has an insertion hole 33 that is opened on the outer periphery at a position different from the opening 3a and that extends toward the support tube 312. An opening of the insertion hole 33 is provided in a portion that is to be placed outside the cavum conchae E1 when the ear device 1 is mounted on the ear E. In the insertion hole 33, an action element 51 of the movement adjuster 5 described later is disposed so as to be movable in an insertion direction of the insertion hole 33. The insertion direction of the insertion hole 33 is referred to as a “movement direction Db” of the action element 51. In the embodiment, the insertion hole 33 extends in a direction substantially orthogonal to the support tube 312 along the axial direction Da of the sound emission rod 4. The action element 51 moves in the insertion direction (movement direction Db) through the insertion hole 33.

In the housing 3, an operation space 34 is formed around a portion where the insertion hole 33 and the support tube 312 intersect with each other. The operation space 34 serves as a movement space for an abutting inclined portion 43 of the sound emission rod 4 described below to move in the axial direction. The insertion hole 33 has a narrow neck portion 331 on the opening side. The narrow neck portion 331 is provided in a portion closer to the outer side with respect to the thickness of the wall inside the housing 3. The inner diameter of the narrow neck portion 331 is smaller than that of the insertion hole 33 on the inner side where the action element 51 is disposed. This prevents the action element 51 from moving beyond the narrow neck portion 331 toward the opening. A groove 332 is formed circumferentially on the inner periphery of the narrow neck portion 331. A flange 524 of a rotary operation element 52, which will be described later, is fitted into the groove 332.

The sound emission rod 4 is supported on one side by the housing 3. In the embodiment, as described above, the sound emission rod 4 is engaged with the housing 3 (support tube 312 of the housing 3) via the elastic member 6. The sound emission rod 4 includes the hollow tubular part 41 and the ear pad 42. One end portion of the tubular part 41 is inserted into the housing 3 through the opening 3a of the housing 3 and is supported by the support tube 312. The tubular part 41 is preferably formed of a sliding material such as POM.

The ear pad 42 is disposed in the other end portion of the tubular part 41, which is the free end portion of the sound emission rod 4 opposite the end portion supported by the housing 3. The ear pad 42 has a rounded tip on a side that is to be faced with the external auditory meatus E2 and is formed into a substantially dome shape overall. The material used to form the ear pad 42 is not particularly limited, but a soft material capable of sealing the external auditory meatus E2 when inserted into the external auditory meatus E2 is applied. The ear pad 42 has sound holes 421 through which the sound converted by the driver unit 2 is emitted. In the embodiment, a plurality of sound holes 421 are provided in the rounded tip of the ear pad 42. By providing a plurality of sound holes 421, even in a case where some of the sound holes 421 are blocked by the walls of the external auditory meatus E2 and the like when the ear pad 42 is inserted into the external auditory meatus E2, sound can be reliably transmitted into the external auditory meatus E2. The tubular part 41 and the ear pad 42 may be one piece or separate.

The abutting inclined portion 43 is formed in an outer peripheral portion of the tubular part 41 at a position corresponding to the above-described operation space 34. The abutting inclined portion 43 has a second inclined surface 431 that is in contact with a first inclined surface 512 formed on the action element 51 of the movement adjuster 5 described below. The second inclined surface 431 has an inclination angle corresponding to the first inclined surface 512. In the embodiment, the insertion hole 33 through which the action element 51 moves is provided substantially orthogonal to the support tube 312. The first inclined surface 512 of the action element 51 and the second inclined surface 431 of the abutting inclined portion 43 that receives the first inclined surface 512 are inclined at an angle of substantially 45 degrees. The second inclined surface 431 slides so as to be pushed out by the first inclined surface 512 according to the movement of the action element 51. Accordingly, the entire sound emission rod 4 moves in the axial direction Da according to the movement of the action element 51.

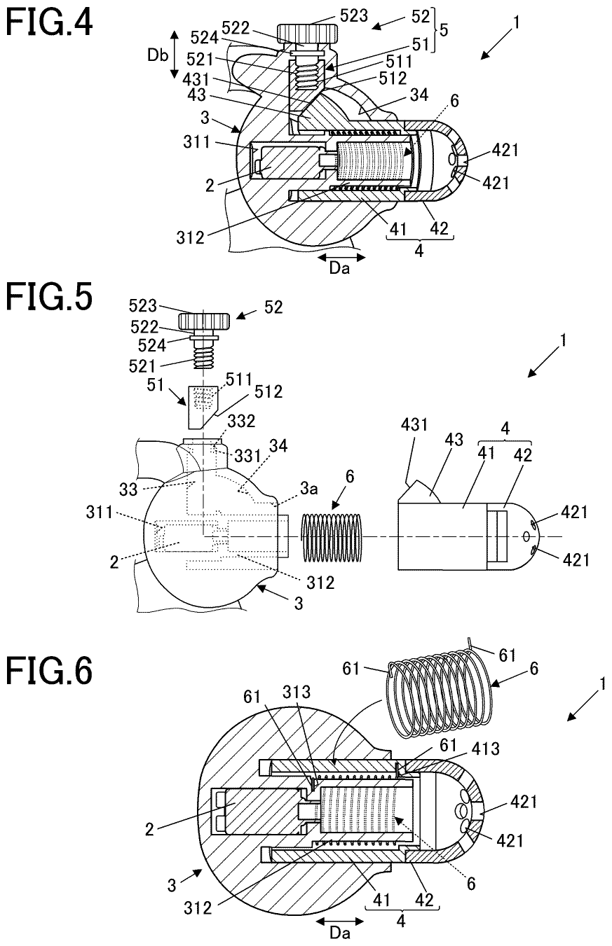

The movement adjuster 5 includes the action element 51 and the rotary operation element 52. The action element 51 is a member that acts on the sound emission rod 4. The action element 51 is disposed in the insertion hole 33 of the housing 3 and is movable in the insertion direction (movement direction Db) through the insertion hole 33, as illustrated in FIG. 4, FIG. 5, and the like. The action element 51 is preferably formed of a sliding material such as POM. As described above, the outer diameter of the action element 51 is larger than the inner diameter of the narrow neck portion 331. This prevents the action element 51 from being pulled out beyond the narrow neck portion 331 toward the opening. The action element 51 has a threaded hole 511 that is opened toward the narrow neck portion 331. A screw portion 521 of the rotary operation element 52 is screwed into the threaded hole 511 from a side facing the narrow neck portion 331. The action element 51 has the first inclined surface 512 such that, in a cross section including a central axis of the sound emission rod along the axial direction Da and parallel to the movement direction Db, a width of the action element in a direction perpendicular to the movement direction becomes narrower toward the tip of the first inclined surface 512 in the movement direction (i.e., on the lower side in the movement direction Db in FIG. 4 and the like). The first inclined surface 512 is in sliding contact with the second inclined surface 431 described above.

The rotary operation element 52 is to be placed outside the cavum conchae E1 when the ear device 1 is mounted. The rotary operation element 52 is an operation element that is operable by the user while mounted. The rotary operation element 52 includes a shaft 522, and an operation head 523 that can be rotated by the user's fingers. The screw portion 521 is formed on one side of the shaft 522, and the operation head 523 is provided on the other side of the shaft 522. The peripheral surface of the operation head 523 is preferably knurled, for example, so as to facilitate operation by the fingers. The flange 524 is formed between the operation head 523 and the screw portion 521 in the shaft 522. The flange 524 is disposed in the groove 332 formed in the narrow neck portion 331, as described above. A portion of the narrow neck portion 331 where the groove 332 is formed has a substantially C-shaped cross section, and the flange 524 is clamped within the groove 332. This prevents the rotary operator 52 from moving in the insertion direction (movement direction Db) of the insertion hole 33 while allowing the rotary operation element 52 to rotate about the axis of the rotary operation element 52.

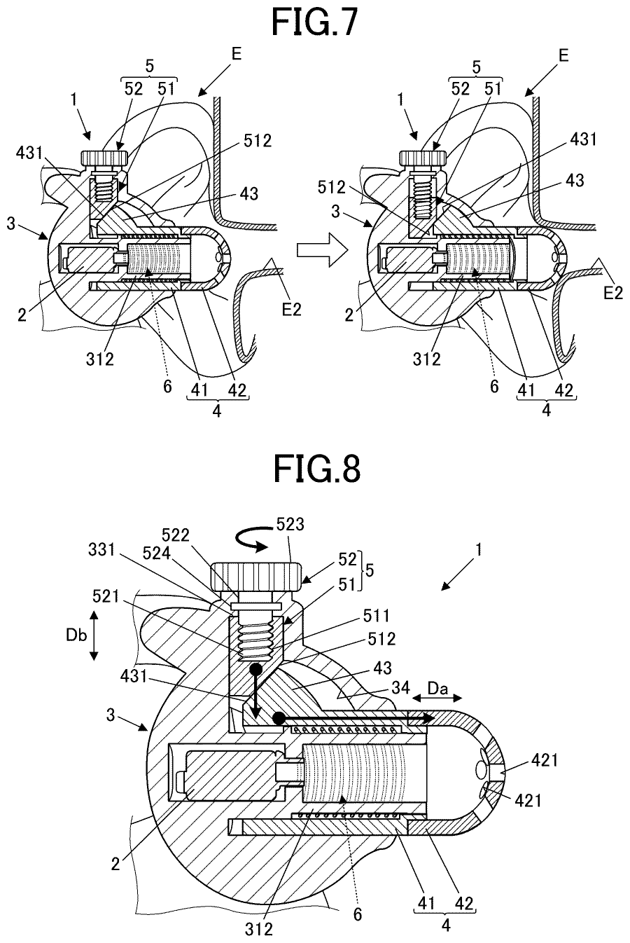

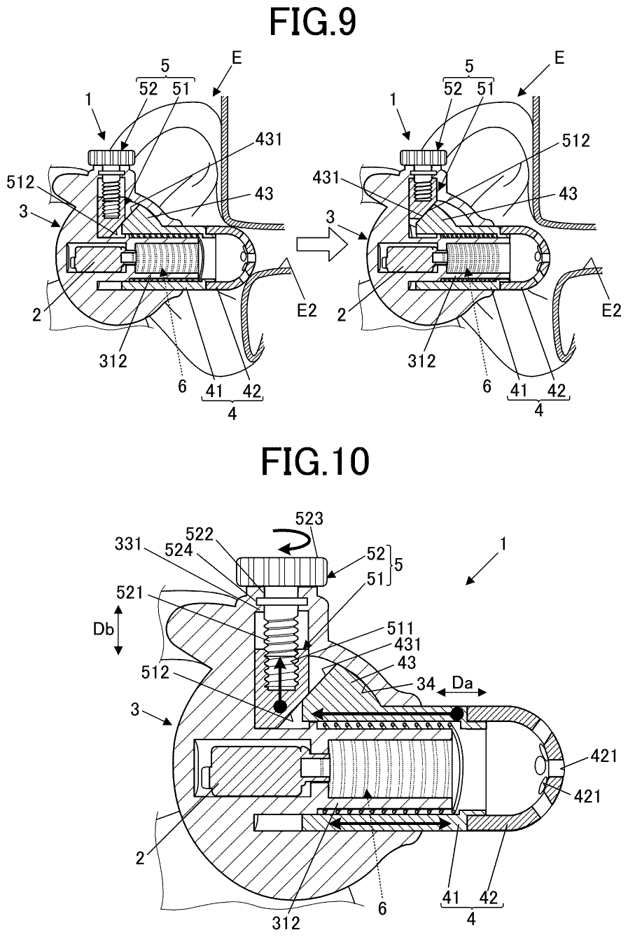

Next, with reference to the drawings, the operations of the ear device 1 and the ear-mounted unit 100 and the method for switching the mounting state of the ear device 1 according to the present embodiment will be explained. In FIGS. 7 and 9, the size of the ear device 1 is shown to be larger than the size of the ear E for illustrative purposes.

As illustrated in FIGS. 1 and 2, when the user mounts the ear-mounted unit 100 according to the embodiment on the ear E, the ear device 1 is placed on the opening side of the external auditory meatus E2 of the ear E, and the housing 3 is fit in the cavum conchae E1. In FIGS. 1 and 2, a position where the housing 3 contacts and is supported by the cavum conchae E1 is defined as a contact point P. The axial direction Da of the sound emission rod 4 of the ear device 1 is set to point toward the inside of the external auditory meatus E2 from this contact point P. When the tip of the sound emission rod 4 (the rounded tip of the ear pad 42) is inserted into the external auditory meatus E2, a pressing force is applied to the ear device 1 in a direction along the axial direction Da from the external auditory meatus E2. However, this pressing force can be received on a side facing the cavum conchae E1 because the housing 3 contacts the cavum conchae E1 at the contact point P. Furthermore, the main body 7, which is connected to the ear device 1 via the arm 8, is placed on the back side of the ear E across the earlobe E3. This allows the ear-mounted unit 100 to be securely mounted on the ear E, preventing the ear-mounted unit 100 from falling off.

In order to switch the mounting state of the ear device 1 (the ear-mounted unit 100 including the ear device 1) between the open state and the closed state, the user operates the rotary operation element 52 of the movement adjuster 5 with fingers as described below. Here, the ear pad 42 is to be placed outside the external auditory meatus E2 in the open state and inserted into the external auditory meatus E2 in the closed state. This makes it possible to change the mounting state to a desired state while the ear-mounted unit 100 is mounted on the ear E.

First, when the ear pad 42 is in the open state (left side of FIG. 7) in which the ear pad 42 is placed outside the external auditory meatus E2, the movement adjuster 5 according to the embodiment is in a state where the action element 51 is screwed to the screw portion 521 and raised to such a degree as to come into contact with the lower end of the narrow neck portion 331 (see the left side of FIG. 7 and FIG. 8). In this state, the second inclined surface 431 of the abutting inclined portion 43 is only in contact with, but not pressed by, the first inclined surface 512. The sound emission rod 4, which is provided with the abutting inclined portion 43, is engaged with the housing 3 via the elastic member 6, which is a return spring. The elastic member 6 is contracted to substantially its natural length in the open state.

When the user wishes to use the ear device 1 (the ear-mounted unit 100 including the ear device 1) as a closed-type by switching the sound emission rod 4 from the open state (the left side of FIG. 7) to the closed state (the right side of FIG. 7), the user rotates the rotary operation element 52 of the movement adjuster 5 counterclockwise, as illustrated in FIG. 8. This causes the action element 51 to be gradually ejected downward (downward in FIG. 8) in the insertion direction (movement direction Db) of the insertion hole 33, as shown by the downward arrow in FIG. 8. As illustrated in FIG. 8, the action element 51 moves in a direction different from the axial direction Da of the sound emission rod 4 (see the rightward arrow in FIG. 8). In the embodiment, the movement direction Db of the action element 51 is a direction that is substantially 90 degrees with respect to the axial direction Da of the sound emission rod 4 pointing toward the inside of the external auditory meatus E2 (see FIGS. 1 and 2). As illustrated in FIGS. 1 and 2, by setting the insertion direction (movement direction Db) of the insertion hole 33 to be substantially orthogonal to the axial direction Da of the sound emission rod 4, the operation head 523 of the rotary operation element 52 can be placed outside the cavum conchae E1. This allows the user to easily operate the rotary operation element 52 while mounting the ear device 1 on the ear E.

When the action element 51 moves downward in the movement direction Db (see the downward arrow in FIG. 8), the second inclined surface 431 slides so as to be pushed out by the first inclined surface 512, and the entire sound emission rod 4 slides toward the external auditory meatus E2 in the axial direction Da against the elastic member 6 (see the rightward arrow in FIG. 8). Thus, in this embodiment, simply pushing the action element 51 straight down in the movement direction Db causes the first inclined surface 512 to push out the second inclined surface 431 along the inclined surface. As a result, the force applied downward in the movement direction Db (downward in FIG. 8) can be effectively converted into a force that moves the sound emission rod 4 rightward in the axial direction Da (rightward in FIG. 8). This also allows at least the ear pad 42, which is provided in the tip of the sound emission rod 4, to be inserted into the external auditory meatus E2. When the ear pad 42 is inserted into the external auditory meatus E2 to be in the closed state, the elastic member 6 is extended longer than its natural length in the axial direction Da. Then, a force for returning the elastic member 6 to its normal, contracted state acts on the elastic member 6. However, when the action element 51 is lowered to the bottom of the insertion hole 33, the second inclined surface 431 of the abutting inclined portion 43 abuts against the first inclined surface 412. This prevents the sound emission rod 4 from returning to the left in the axial direction Da, thereby maintaining the position of the sound emission rod 4 in the axial direction Da (see the right side of FIG. 7).

Conversely, when the user wishes to use the ear device 1 (the ear-mounted unit 100 including the ear device 1) as an open-type by switching the sound emission rod 4 from the closed state (the left side of FIG. 9) to the open state (the right side of FIG. 9), the user rotates the rotary operation element 52 of the movement adjuster 5 clockwise, as illustrated in FIG. 10. This causes the action element 51 to be gradually pulled upward (upward in FIG. 10) in the insertion direction (movement direction Db) of the insertion hole 33 by the screw portion 521 of the rotary operation element 52, as shown by the upward arrow in FIG. 10. When the action element 51 is moved upward, the second inclined surface 431 becomes movable in the left direction of the axial direction Da (see the leftward arrow in FIG. 10) to an extent that the first inclined surface 412 has been retracted upward, and the sound emission rod 4 is pulled back in the left direction of the axial direction Da by a restoring force for restoring the elastic member 6 to its normal, contracted state. As a result, the ear pad 42, which is provided in the tip of the sound emission rod 4, is placed outside the external auditory meatus E2.

There are advantages and disadvantages in each of the following cases: a case where the ear device 1 (the ear-mounted unit 100 including the ear device 1) is used as an open-type by keeping the sound emission rod 4 in the open state with the tip of the sound emission rod 4, in which the sound holes 421 are formed, outside the external auditory meatus E2; and a case where the ear device 1 (the ear-mounted unit 100 including the ear device 1) is used as a closed-type by keeping the sound emission rod 4 in the closed state with the tip of the sound emission rod 4 inserted into the external auditory meatus E2. For example, an open-type ear device 1 allows the user to hear external sounds. Thus, the user can hear the sound converted by the driver unit 2 while being aware of the surrounding situation, for example, when walking, riding on a train, or participating in an online meeting. In addition, by keeping the earhole (external auditory canal E2) open without blocking it, a sense of discomfort or a sense of muffled sound is less likely to occur, and discomfort caused by moisture buildup is also prevented. This allows the ear device 1 (ear-mounted unit 100 including the ear device 1) to be used comfortably for a long period of time. On the other hand, the further the sound holes 421 is separated from the entrance of the external auditory meatus E2, the lower the sound pressure reaching the eardrum becomes, making it more difficult for the user to hear the sound. In addition, placing the sound holes 421 outside the external auditory meatus E2 increases the risk of sound leakage to the surroundings. In this regard, the user can hear a clear, high-quality sound with a closed-type ear device 1 without worrying about the sound leakage. This allows the user to immerse himself/herself in music or the like. In addition, creating a sealed environment enables effective noise cancellation to eliminate extraneous noise. The ear device 1 (ear-mounted unit 100 including the ear device 1) according to the present embodiment can be easily switched between open-type and closed-type by the user himself/herself as needed with a relatively simple configuration. This allows a single device to be used in various situations.

As described above, the ear device 1 according to the present embodiment includes: the housing 3; the sound emission rod 4 that is connected to the housing 3 and has the sound holes 421; and the movement adjuster 5 that moves the sound emission rod 4 in the axial direction Da relative to the housing 3 according to a user operation on the movement adjuster 5. According to the user operation, the state of the sound emission rod 4 is switchable between: the closed state in which the sound holes 421 of the sound emission rod 4 are to be placed inside the external auditory meatus E2; and the open state in which the sound holes 421 of the sound emission rod 4 are to be placed outside the external auditory meatus E2. This allows the user to easily switch the ear device 1 between closed-type and open-type, enabling a single ear device 1 to be used for either type as appropriate. This allows the user to adapt to different situations as needed. For example, when the user is concerned about sound leakage to the surroundings or wishes to immerse himself/herself in music or the like, the user can use the device as a closed-type ear device to enjoy high-quality sound with peace of mind. When the user wishes to be aware of the surroundings or use the device comfortably for a long period of time, the user can use the device as an open-type ear device to reduce strain on the ear E.

The movement adjuster 5 according to the embodiment includes the rotary operation element 52 that is to be placed outside the cavum conchae E1 and is operable by the user while mounted. This allows the user to easily switch between open-type and closed-type.

The movement adjuster 5 according to the embodiment includes the action element 51 that moves in a direction different from the axial direction Da of the sound emission rod 4 (movement direction Db) to act on the sound emission rod 4. The sound emission rod 4 moves in the axial direction Da according to the movement of the action element 51. In the embodiment, the movement direction of the action element 51 (movement direction Db) is a direction that is substantially 90 degrees with respect to the axial direction Da of the sound emission rod 4. As illustrated in FIGS. 1 and 2, the axial direction Da of the sound emission rod 4 is substantially equal to the extension direction of the external auditory meatus E2, making it difficult to operate the sound emission rod 4 from the axial direction Da. In this regard, by operating the action element 51 from a direction different from the axial direction Da, particularly from a direction that is substantially 90 degrees with respect to the axial direction Da, it is possible to easily apply a force to the movement adjuster 5 to stably operate the movement adjuster 5, thereby enabling the sound emission rod 4 to move in the axis direction Da.

In the embodiment, the action element 51 has the first inclined surface 512 such that, in a cross section including the central axis of the sound emission rod along the axial direction Da and parallel to the movement direction Db, the width of the action element in the direction perpendicular to the movement direction becomes narrower toward the tip of the first inclined surface 512 in the movement direction (movement direction Db). The sound emission rod 4 has the second inclined surface 431 that has an inclination angle corresponding to the first inclined surface 512. When the action element 51 moves in the movement direction (movement direction Db) with the first inclined surface 512 in contact with the second inclined surface 431, the second inclined surface 431 slides against the first inclined surface 512, and the sound emission rod 4 moves in the axial direction Da. Thus, the sound emission rod 4 can be moved in the axial direction Da by an operation from a direction different from the axial direction Da with a relatively simple configuration in which the inclined surfaces abut against each other for sliding.

The sound emission rod 4 according to the embodiment is engaged with the housing 3 via the elastic member 6. The elastic member 6 is contracted to a length substantially equal to its natural length when the sound emission rod 4 is in the open state. The elastic member 6 is extended in the axial direction Da to a length longer than its natural length when the sound emission rod 4 is in the closed state. When the elastic member 6 is extended, the restoring force for returning the elastic member 6 to its normal, contracted state acts on the elastic member 6. Therefore, in the closed state, only by changing the position in the axial direction Da where the second inclined surface 431 abuts against the first inclined surface 512, the sound emission rod 4 is automatically pulled back by the restoring force of the elastic member 6, thereby enabling the sound emission rod 4 to return to the open state.

The ear-mounted unit 100 according to the embodiment includes the ear device 1 described in the embodiment, the main body 7 that is to be placed on the back side of the ear E when mounted, and the arm 8 that connects the main body 7 to the ear device 1. This allows the main body 7 and ear device 1 to pinch the ear E from both sides, enabling the ear-mounted unit 100 to be securely mounted on the ear E.

Although an embodiment of the present invention is described above, it is needless to say that the present invention is not limited to the embodiment and various changes can be made without departing from the scope of the present disclosure.

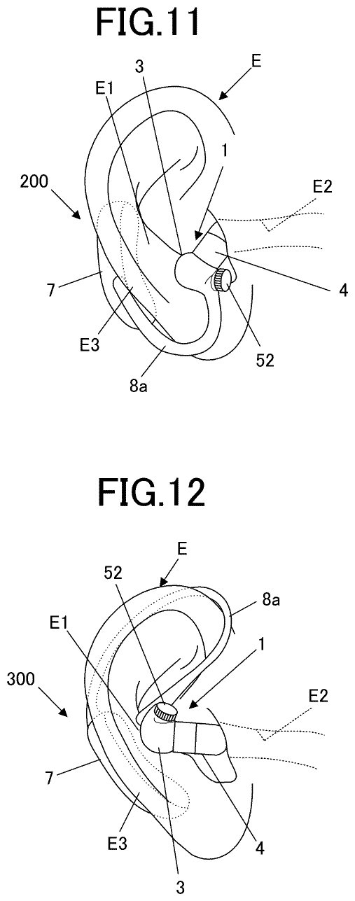

For example, in the ear-mounted unit 100 according to the above embodiment, a case is exemplified where the arm 8 connecting the ear device 1 to the main body 7 crosses the earlobe E3, resembling an ear cuff, with the ear device 1 fit in the cavum conchae E1 and the main body placed on the back side of the ear E. However, the configuration of the ear-mounted unit 100 is not limited thereto. For example, as illustrated in FIG. 11, an ear-mounted unit 200 may be configured such that an arm 8a connecting the ear device 1 to the main body 7 passes under the earlobe E3. As illustrated in FIG. 12, an ear-mounted unit 300 may be configured such that an arm 8b connecting the ear device 1 to the main body 7 passes above the earlobe E3.

In the above embodiment, a case is exemplified where the ear device 1 is provided in the ear-mounted unit 100 including the main body 7 and the arm 8, but the ear device 1 may be used alone without being connected to the main body 7, the arm 8, and the like. For example, a communication module, various circuit boards, and the like may be built in the ear device so that the ear device can communicate with various electronic devices such as a smartphone, receive a sound signal from the electronic devices in a wireless manner, and emit sound through the sound holes 421. The ear device may also be connected to various audio devices, and the like in a wired manner. When the ear device is used alone as described above, the housing includes a second contact portion or the like that is fit to the cavum conchae E1 at a position different from the contact point P, so that the housing is fit to the cavum conchae E1 at least two positions. This prevents the ear device from falling off without having to pinch the ear E between the ear device and the main body.

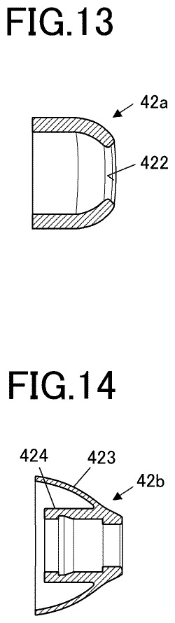

In the above embodiment, a case is exemplified where the ear pad 42 provided in the sound emission rod 4 has the plurality of sound holes 421 on the tip side formed in a substantially dome shape, but the shape and configuration of the ear pad are not limited thereto. For example, as illustrated in FIG. 13, an ear pad 42a may have a single sound hole 422 on the tip side. Furthermore, for example, a hollow fitting rod may be provided in the free end portion of the tubular part 41 of the sound emission rod 4, and an ear pad 42b may include a fitting tube 424 that is fit to the fitting rod inside a dome-shaped umbrella portion 423 as illustrated in FIG. 14.

The distance from the cavum conchae E1 to the external auditory meatus E2 varies from person to person. In addition, different users have their own preferences when using the ear device as a closed type, such as those who prefer to place the sound emission rod 4 near the entrance of the external auditory meatus E2 or those who prefer to insert the sound emission rod 4 deep into the external auditory meatus E2. For this reason, a plurality of ear pads having different sizes (lengths in the axial direction Da) may be prepared so that when the sound emission rod 4 is moved to the external auditory meatus E2 to the limit where the sound emission rod 4 can be moved by the movement adjuster 5, the tip of the sound emission rod 4 can reliably reach the position where the user's desired sealing condition is achieved. Furthermore, an attachment that can be detachably attached between the tubular part 41 and the ear pad 42 and that can change the length in the axial direction Da may be provided for the sound emission rod 4. In addition, an expandable bellows or the like that can be adjusted to a desired length by the user may be provided in a portion of the ear pad or attachment, or the like. When the plurality of different ear pads is prepared, it is preferable that the user can exchange the ear pads from each other as appropriate according to the fit and ease of use. When the attachment is prepared, it is preferable that the user can attach or detach the attachment as appropriate according to the fit and ease of use.

The configuration of the movement adjuster 5 described in the above embodiment is an example and can be changed as needed. For example, in the embodiment, a case is exemplified where the movement adjuster 5 includes, as an operation element operated by the user, the rotary operation element 52 that is rotated to move the action element 51, but the operation element is not limited to a rotary type. For example, the operation element may be pressed like a push button to move the action element 51 in one or multiple steps. In the embodiment, moving the first inclined surface 512 in the movement direction Db causes the second inclined surface 431 in contact with the first inclined surface 512 to slide, thereby moving the sound emission rod 4 in the axial direction Da. However, the configuration for moving the sound emission rod 4 in the axial direction Da is not limited thereto. The axial direction Da and the movement direction Db are in different directions and are preferably orthogonal to each other for efficient operation. However, the axial direction Da and the movement direction Db are not necessarily orthogonal to each other. When the axial direction Da and the movement direction Db are not orthogonal to each other, the inclination angles of the first inclined surface 512 and the second inclined surface 431 are not necessarily 45 degrees but are adjusted to appropriate corresponding angles.

In the above embodiment, a case where the elastic member 6 is a coil spring is exemplified. However, the elastic member 6 is not limited to a coil spring as long as the elastic member 6 can automatically return the sound emission rod 4, which has been moved in the axial direction Da by the movement adjuster 5, to its original position. For example, the elastic member 6 may be a coil spring that is extended in its normal state. In this case, for example, the elastic member 6 is configured to be contracted when the sound emission rod 4 is moved in the axial direction Da by the movement adjuster 5. When the movement restriction by the movement adjuster 5 is released, the sound emission rod 4 returns to its original position by a restoring force for returning the elastic member 6 to its normal, extended state.

In the above embodiment, a case is exemplified where the ear device 1 (ear-mounted unit 100 including the ear device 1) can be switched between open-type and closed-type while mounted on the ear E. However, the ear device 1 (ear-mounted unit 100 including the ear device 1) may be switched between open-type and closed-type while removed from the ear E.

Although some embodiments of the present invention have been described above, the scope of the present invention is not limited to the embodiments described above but includes the scope of the invention described in the claims and its equivalents.

1. An ear device comprising:
a housing;
a sound emission rod that is connected to the housing and has a sound hole; and
a movement adjuster that moves the sound emission rod in an axial direction of the sound emission rod relative to the housing according to a user operation on the movement adjuster, wherein
according to the user operation, a state of the sound emission rod is switchable between:
a closed state in which the sound hole of the sound emission rod is to be placed inside an external auditory meatus of an ear of a user; and
an open state in which the sound hole of the sound emission rod is to be placed outside the external auditory meatus.

2. The ear device according to claim 1, wherein the movement adjuster includes an operation element that is to be placed outside a cavum conchae of the ear of the user and that is operable by the user while the ear device is mounted on the ear.

3. The ear device according to claim 1, wherein
the movement adjuster includes an action element that moves in a movement direction different from the axial direction of the sound emission rod to act on the sound emission rod, and
the sound emission rod moves in the axial direction according to a movement of the action element.

4. The ear device according to claim 3, wherein the movement direction of the action element is a direction that is substantially 90 degrees with respect to the axial direction of the sound emission rod.

5. The ear device according to claim 3, wherein:
the action element has a first inclined surface such that, in a cross section including a central axis of the sound emission rod along the axial direction and parallel to the movement direction of the action element, a width of the action element in a direction perpendicular to the movement direction becomes narrower toward a tip of the first inclined surface in the movement direction;
the sound emission rod has a second inclined surface that has an inclination angle corresponding to the first inclined surface; and,
when the action element moves in the movement direction with the first inclined surface in contact with the second inclined surface,
the second inclined surface slides against the first inclined surface, and
the sound emission rod moves in the axial direction.

6. The ear device according to claim 1, wherein
the sound emission rod is engaged with the housing via an elastic member,
the elastic member is contracted to a length substantially equal to a natural length of the elastic member when the sound emission rod is in the open state, and
the elastic member is extended in the axial direction to a length longer than the natural length when the sound emission rod is in the closed state.

7. An ear-mounted unit comprising:
the ear device according to claim 1;
a main body that is to be placed on a back side of the ear when the ear-mounted unit is mounted on the ear; and
an arm that connects the main body to the ear device.

8. A method for switching a mounting state of an ear device that includes:
a housing that is to be fit in a cavum conchae of an ear of a user; and
a sound emission rod that is supported by the housing and has a sound hole through which sound is emitted, the sound hole being provided in a free end portion of the sound emission rod,
the method comprising
moving the sound emission rod in an axial direction of the sound emission rod relative to the housing by a user operation, so as to switch the mounting state between:
a closed state in which at least the free end portion of the sound emission rod is to be inserted inside an external auditory meatus of the ear; and
an open state in which the sound emission rod is to be placed outside the external auditory meatus.
